(19) United States
(12) Patent Application Publication
(10) Pub. No.: US 2019/0322533 A1
(43) Pub. Date: Oct. 24, 2019

(54) PROCESS FOR PRODUCING SILICON INGOT BY SMELTING SILICON POWDER

(71) Applicant: ChengDu Silicon Technology Co., Ltd., Chengdu, Sichuan (CN)

(72) Inventors: Shi Yang, Chengdu, Sichuan (CN); Xu Zhou, Chengdu, Sichuan (CN)

(21) Appl. No.: 16/467,040

(22) PCT Filed: Dec. 7, 2017
(86) PCT No.: PCT/CN2017/115079

§ 371 Date: Jun. 5, 2019

(30) Foreign Application Priority Data
Dec. 9, 2016 (CN) 201611131075.9

(51) Int. Cl. C01B 33/037

(52) U.S. Cl. CPC C01B 33/037

(57) ABSTRACT

A process for producing a silicon ingot by smelting silicon powder, including (a) furnace starting: preparing a silicon liquid having a standard purity in an intermediate frequency furnace; (b) silicon smelting: adding the silicon power to the silicon liquid for smelting, so as to obtain a silicon liquid; and (c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot. The present invention uses weak conductivity of the silicon liquid to realize induction heating, achieving the purpose of smelting the silicon block. The approach provided by the present invention that uses the induction furnace to smelt silicon can largely improve the production and output efficiency.

### FIELD OF THE INVENTION

The present invention relates to the field of recycling silicon slag, and more particularly to a process for producing a silicon ingot by smelting silicon powder.

### BACKGROUND OF THE INVENTION

Silicon slag generally refers to a remainder in refining processes of a raw ore, which still contains a quantity of silicon. The silicon slag has various kinds such as industrial silicon slag, solar silicon slag, semiconductor silicon slag and the like. The silicon slag can be recycled and purified to address the problems of a lack of silicon and a high price. Silicomanganese slag, also called silicomanganese smelting slag, is industrial waste slag discharged from the smelting process of the silicomanganese alloy, which has a loose structure and an appearance of light green particles, and is composed of some irregular porous amorphous particles. The silicomanganese slag is fragile and brittle, the bulk silicomanganese slag can be being crushed into small pieces by a crusher, and the roughly crushed material is further pulverized in a fine crusher to ensure that the material entering the silo can reach a degree of monomeric liberation, and is then sorted by being evenly fed into a trapezoid jigger via a vibrating feeder and a belt conveyor. A main purpose of the crush is to break the aggregate structure, while a main purpose of the jigging is to recycle the silicomanganese alloy from the silicomanganese slag. The differences in specific gravity of the silicomanganese slag and the silicomanganese alloy are relatively large, the waste slag being able to be separated from the metal by the gravity separation function of the jigger, thereby obtaining pure alloy and waste slag, and in the end the concentrate ore and gangue being able to be dehydrated respectively by the dehydrating effect of the dewatering screen.

An induction furnace is an electric furnace using the induction heating effect of materials to heat or melt the materials. The alternating current power used by the induction furnace includes three kinds of power frequency (50 or 60 hertz), intermediate frequency (150-10000 hertz) and high frequency (more than 10000 hertz). The main components of the induction furnace comprise an inductor, a furnace body, a power supply, a capacitor and a control system, etc. Under the action of the alternating electromagnetic field in the induction furnace, an eddy current is generated in the materials to thereby achieve the heating or melting effect. The induction furnace generally includes the induction heating furnace and the smelting furnace. The smelting furnace is divided into two types of the core induction furnace and the coreless induction furnace. The core induction furnace is mainly used for the smelting and thermal insulation of various cast irons and other metal, and can utilize the waste furnace materials, thereby lowering the smelting cost. The coreless induction comprises a power frequency induction furnace, a triple frequency induction furnace, a generator set intermediate frequency induction furnace, a thyristor intermediate induction furnace and a high frequency induction furnace. According to the frequency, the induction furnace is divided into three types of a power frequency furnace 50 hertz, intermediate frequency furnace (150-10000 hertz) and a high frequency furnace (more than 10000 hertz).

The main device used for the current silicon smelting process is the crucible, and the technology that uses crucible to perform the silicon smelting is relatively mature, however a fatal fault of the crucible is the quite small capacity, causing the small amount of the single smelting and the difficult mass production, which has restricted the development of silicon.

### BRIEF SUMMARY OF THE INVENTION

The present invention aims to provide a process for producing a silicon ingot by smelting silicon powder, which is established to improve the efficiency of the silicon smelting, thereby greatly increasing the silicon production, and achieving the purpose of reducing cost of mass production.

The present invention is realized by the following technical solutions:

(a) furnace starting: preparing a silicon liquid having a standard purity in an intermediate frequency furnace;

(b) silicon smelting: adding the silicon power to the silicon liquid for smelting, so as to obtain a silicon liquid; and

(c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot.

The applicant of the present invention found that the traditional smelting technologies for silicon always used a crucible, but the shape and physical properties of the crucible itself determined that its size cannot be too large, which the latter limited the production. The applicant has done detailed research on the induction furnaces used in the smelting technologies, which are all used to smelt metal. However, the silicon is a non-metal material which cannot be smelted by the induction furnaces. In order to improve the output efficiency of the silicon smelting, the applicant has delved into the induction furnace and silicon and found that a silicon liquid having weak conductivity can also generate slight inductive heat. As the existing induction furnaces cannot be used as the tool for silicon smelting, the applicant has improved the equipment and process to use the induction furnace for silicon smelting, which overcame the technical prejudice and used the weak conductivity of the silicon liquid to perform the induction heating, achieving the purpose of smelting the silicon block. Compared with the crucible's maximum capacity of 20 KG, the means provided by the present invention that uses the induction furnace to perform the silicon smelting can increase the smelting amount of a single furnace to 5 tons, which compared with the crucible smelting in prior art can largely improve the production and output efficiency.

During the furnace starting in step (a), any one of an iron block furnace starting method, an aluminum block furnace starting method, graphite furnace starting method and an electron beam gun furnace starting method is adopted. The aforementioned furnace starting methods have some differences, and the detailed steps are as follows:

The first method: the iron block furnace starting method comprises following steps:

(a11) placing a silicon block or the silicon powder in an induction furnace, and simultaneously adding an iron block to the induction furnace;

(a12) starting the induction furnace, and raising a temperature to 1480-1520° C.; and

(a13) melting the silicon block or the silicon powder into a silicon liquid, and removing the iron block.

During the furnace starting step, the iron block is added to the silicon block, and the temperature is heated to 1480-1520° C., wherein the temperature at this time reaches the melting temperature of silicon but is yet below the melting temperature of iron. The iron block used as the heat generating component of the induction furnace generates significant amounts of heat which is absorbed by the silicon block. The heat heats the silicon block to the melting point so that the silicon block is melted into the silicon liquid, while the iron block does not reach its melting point and remain solid. Thereafter, the iron block is removed, and weak conductivity of the silicon liquid is used for self-induction heating generation, achieving the purpose of smelting the silicon block.

The second method: the aluminum block furnace starting method comprises following steps:

(a21) placing a silicon block or the silicon powder in an induction furnace, and simultaneously adding an aluminum ingot to the induction furnace;

(a22) starting the induction furnace, and raising a temperature to 700-800° C. to melt the aluminum ingot to an aluminum liquid;

(a23) continuously raising the temperature to 1700-1800° C. to melt the silicon block or the silicon powder into a silicon liquid;

(a24) gradually adding a silicon block or a silicon powder to the mixed liquid prepared in step (a23), so as to increase a silicon content in the silicon-aluminum mixed liquid; and as the mixed liquid in the induction furnace being full, removing 85%-95% of the mixed liquid and adding anew a silicon block or a silicon powder gradually; and

(a25) repeating step (a24) until the silicon content in the mixed liquid reaching a standard, then completing the furnace starting.

During the furnace starting step, the aluminum ingot is added to the silicon block, and the temperature is heated to 700-800° C. which has reached the melting temperature of the aluminum so that the aluminum ingot is melted into an aluminum liquid. The aluminum ingot is used as the heat generating component of the induction furnace. Next, the temperature is continuously heated to 1700-1800° C. Then the silicon block absorbs the heat and is melted to form the silicon liquid as its temperature reaches the melting temperature. The weak conductivity of the silicon liquid can also be used for self-induction heating generation, thereby achieving the purpose of smelting the silicon block. The high conductivity of the mixed liquid of the aluminum liquid and the silicon liquid is able to smelt the silicon rapidly. Then the principle of dilution is used to dilute the silicon liquid several times to obtain a desired silicon liquid, thereby completing the furnace starting in a short time, so as to satisfy the requirements of mass production.

The third method, the graphite furnace starting method comprises following steps:

(a31) placing a silicon block or the silicon powder in an induction furnace, and simultaneously adding a graphite block to the induction furnace;

(a32) starting the induction furnace, and raising a temperature to 1800-1900° C.; and

(a33) melting the silicon block and the silicon powder to a silicon liquid, and removing the graphite block.

In a way that adds graphite to the silicon block during the furnace starting step, as well as raises the temperature to 1800-1900° C., the temperature at this moment exceeds the melting temperature of silicon but is below the melting temperature of the graphite block. The graphite block has electrical conductivity. With induction heating principle of the graphite block, the graphite block can be used as the heat generating component of the induction furnace to generate significant amounts of heat. The silicon block absorbs the heat and is heated to its melting temperature to form the silicon liquid, while the graphite block is below its melting point and remains solid. Thereafter, the graphite block is removed, and weak conductivity of the silicon liquid is used for self-induction heating generation, achieving the purpose of smelting the silicon block.

The forth method: the electron beam gun furnace starting method comprises following steps:

(a41) placing the silicon powder or a silicon block in an inside of an induction furnace (1);

(a42) starting an electron beam gun, and using the electron beam gun to heat the silicon powder or the silicon bock, so as to prepare a silicon liquid;

(a43) at the same time as performing step (b), starting the induction furnace (1) to raise a temperature; and

(a44) after the silicon powder or the silicon block completely melting into the silicon liquid, stopping heating of the electron beam gun, and completing the furnace starting.

One or more electron beam guns are disposed on the induction furnace. The focused heating means of the electron beam guns is used to heat the silicon powder in the induction furnace. When a part of the silicon liquid is formed under the heating, the induction furnace is started and uses weak conductivity of the silicon liquid to carry out induction heating, thereby forming more silicon liquid. The combination of the electron beam guns and the induction furnace can efficiently smelt the silicon block in a short time, completing the furnace starting step of the silicon smelting, and achieving the purpose of using induction furnace to smelt silicon.

During the silicon smelting in step (b), the silicon liquid is also stirred, wherein an operating procedure is: using a wood stick to stir the silicon liquid clockwise or counterclockwise in a single direction, and stir 2-3 cycles per minute. In practical manufacturing processes, the applicant found that the flow of the silicon liquid is advantageous for induction heating, and the additional stirring operation in the furnace starting process can rapidly spread the heat generated by the silicon liquid, thereby expediting a fusion of the silicon powder or the silicon block. In prior art, a graphite stick is usually used as the operation tool for the silicon smelting process. However, due to the softness of the graphite stick itself, it has quite low strength and is easily to be broken. Thus the consumption of graphite not only increases the cost, but also restricts the development of the silicon smelting. Accordingly, through many years of exploration, the applicant found that a wood stick is a consumable that can be used as the stirring means for silicon smelting, and is gradually burned at a high temperature and discharged with the exhaust gas. Compared with the prior art, the use of the wood stick not only reduces the cost, but also introduces no impurities, solving the problem that the graphite becomes the impurity, thereby improving the quality of products.

The operating frequency of the intermediate frequency furnace is 100-140 HZ. The applicant has conducted tens of thousands of experiments on the existing induction furnace, through which the applicant found the type of the induction furnace able to be used for silicon smelting: the intermediate frequency furnace. However, not all the intermediate frequency furnaces are available. In the prior art, the intermediate frequency furnaces have a frequency of 150-10000 HZ. Although the present invention adopts the structure of the intermediate frequency furnace, the operating parameters thereof are significantly adjusted to have an operating parameter of 100-140 HZ, which the latter is actually an abnormal operating range of the intermediate frequency furnace. Using the abnormal operating conditions to smelt the silicon is greatly beyond the knowledge of the people skilled in the art, and also meets the requirements of the silicon smelting, achieving unexpected advantages, appearing thorough progress in the field of silicon smelting, significantly increasing the mass production of silicon smelting and promoting the development of the industry.

Compared with the prior art, the present invention has following advantages and beneficial effects:

1. The present invention discloses a process for producing a silicon ingot by smelting silicon powder. During the furnace starting step, the iron block is added to the silicon block, and the temperature is heated to 1480-1520° C., wherein the temperature at this time reaches the melting temperature of silicon but is yet below the melting temperature of iron. The iron block used as the heat generating component of the induction furnace generates significant amounts of heat which is absorbed by the silicon block. The heat heats the silicon block to the melting point so that the silicon block is melted into the silicon liquid, while the iron block does not reach its melting point and remain solid. Thereafter, the iron block is removed, and weak conductivity of the silicon liquid is used for self-induction heating generation, achieving the purpose of smelting the silicon block. Compared with the crucible's maximum capacity of 20 KG, the means provided by the present invention that uses the induction furnace to perform the silicon smelting can increase the smelting amount of a single furnace to 5 tons, which compared with the crucible smelting in prior art can largely improve the production and output efficiency.

2. The present invention discloses a process for producing a silicon ingot by smelting silicon powder. The operating parameters of the intermediate frequency furnace are significantly adjusted to have an operating parameter of 100-140 HZ, which the latter is actually an abnormal operating range of the intermediate frequency furnace. Using the abnormal operating conditions to smelt the silicon is greatly beyond the knowledge of the people skilled in the art, and also meets the requirements of the silicon smelting, achieving unexpected advantages, appearing thorough progress in the field of silicon smelting, significantly increasing the mass production of silicon smelting and promoting the development of the industry.

### DETAILED DESCRIPTION OF THE PREFERRED EMBODIMENTS

In order to clarify the purpose, solution and advantages for the present invention, with reference to the accompanying embodiments and drawings, the present invention is further described in detail, the embodiments and the illustrations thereof is merely illustrative of the invention and are not intended to limit the invention.

### Example 1

The present invention providing a process for producing a silicon ingot by smelting silicon powder follows the following steps:

(a11) placing a silicon block or silicon powder in an intermediate induction furnace, and simultaneously adding an iron block to the intermediate induction furnace, wherein a weight ratio of the silicon block to the iron block is 1:1;

(a12) starting the intermediate induction furnace, setting an operating frequency of the intermediate frequency furnace to 120 HZ, the iron block being heated and heating the silicon, the silicon block reaching its melting point and raising a temperature to 1480-1520° C.;

(a13) melting the silicon block into a silicon liquid, removing the iron block, and completing furnace starting;

(b) silicon smelting: adding the silicon power to the silicon liquid for smelting, during the silicon smelting, using a wooden stick to stir the silicon liquid clockwise or counterclockwise in a single direction, and stir 2-3 cycles per minute to obtain a silicon liquid; and

(c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot.

### Example 2

A process for producing a silicon ingot by smelting silicon powder, comprising following steps:

(a21) placing a silicon block or silicon powder in an intermediate induction furnace, and simultaneously adding an aluminum ingot to the intermediate induction furnace, wherein a weight ratio of the silicon block to the aluminum ingot is 2:1;

(a22) starting the induction furnace, setting an operating frequency of the intermediate frequency furnace to 120 HZ to heat the aluminum ingot, and raising a temperature to 700-800° C. to melt the aluminum ingot to an aluminum liquid;

(a23) continuously raising the temperature to 1700-1800° C. to melt the silicon block or the silicon powder into a silicon liquid;

(a24) gradually adding a silicon block or a silicon powder to the mixed liquid prepared in step (a23), so as to increase a silicon content in the silicon-aluminum mixed liquid; and as the mixed liquid in the induction furnace being full, removing 85%-95% of the mixed liquid and adding anew a silicon block or a silicon powder gradually;

(a25) repeating step (a24) until the silicon content in the mixed liquid reaching a standard, then completing furnace starting;

(b) silicon smelting: adding the silicon power to the silicon liquid for smelting, during the silicon smelting, using a wooden stick to stir the silicon liquid clockwise or counterclockwise in a single direction, and stir 2-3 cycles per minute to obtain a silicon liquid; and

(c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot.

### Example 3

A process for producing a silicon ingot by smelting silicon powder, comprising following steps:

(a31) placing a silicon block or the silicon powder in an intermediate induction furnace, and simultaneously adding graphite to the intermediate induction furnace, wherein a weight ratio of the silicon block to the graphite is 0.6:1;

(a32) starting the intermediate induction furnace, setting an operating frequency of the intermediate frequency furnace to 110 HZ, the graphite being heated and heating the silicon, the silicon block reaching its melting point and raising a temperature to 1800-1900° C.;

(a33) melting the silicon block to a silicon liquid, removing the graphite, and completing furnace starting;

(b) silicon smelting: adding the silicon power to the silicon liquid for smelting, during the silicon smelting, using a wooden stick to stir the silicon liquid clockwise or counterclockwise in a single direction, and stir 2-3 cycles per minute to obtain a silicon liquid; and

(c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot.

### Example 4

A process for producing a silicon ingot by smelting silicon powder, comprising following steps:

(a41) placing silicon powder or a silicon block in an inside of an intermediate induction furnace;

(a42) starting an electron beam gun, and using the electron beam gun to heat the silicon powder or the silicon bock, so as to prepare a silicon liquid;

(a43) at the same time as performing step (a42), starting the intermediate induction furnace to raise a temperature, wherein an operating frequency of the intermediate induction furnace is 120-130 HZ; when performing step (a42) and step (a43), the silicon liquid being also stirred, wherein an operating procedure is: using a wood stick to stir the silicon liquid clockwise or counterclockwise in a single direction, and stir 2-3 cycles per minute;

(a44) after the silicon powder or the silicon block completely melting into the silicon liquid, stopping heating of the electron beam gun, and completing the furnace starting;

(b) silicon smelting: adding the silicon power to the silicon liquid for smelting, during the silicon smelting, using a wooden stick to stir the silicon liquid clockwise or counterclockwise in a single direction, and stir 2-3 cycles per minute to obtain a silicon liquid; and

(c) molding: reserving a silicon liquid accounting for 15%-20% of a capacity of the silicon liquid in the intermediate frequency furnace as an initial silicon liquid for a next smelting, and pouring the rest of the silicon liquid into a molding system, thereby producing the silicon ingot.

In the aforementioned four examples, a single capacity of the intermediate induction furnace is 3.5 tons. According to the specification and the prior technology, the capacity can be increased to 5 tons, the single time for furnace starting is from 12 to 15 minutes, and the single smelting time is 80-100 minutes, which greatly improves the production efficiency compared to the production method of the crucible.

The specific embodiment described above further explains the purposes, technical solutions and beneficial effects of the present invention. It is to be understood that the foregoing is only illustrative of the embodiment of the present invention, and is not intended to limit the scope of the present invention. Any modifications, equivalents, and improvements made within the spirit and scope of the present invention should be included in the scope of protection of the present invention.

1. A process for producing a silicon ingot by smelting silicon powder, comprising following steps:
(a) furnace starting: preparing a first silicon liquid having a standard purity in an intermediate frequency furnace;
(b) silicon smelting: adding the silicon power to the first silicon liquid for smelting, so as to obtain a second silicon liquid; and
(c) molding: reserving a third silicon liquid accounting for 15%-20% of a capacity of the second silicon liquid in the intermediate frequency furnace as an initial silicon liquid for a next smelting, and pouring the rest of the second silicon liquid into a molding system, thereby producing the silicon ingot.

2. The process of claim 1, wherein in step (a), any one of an iron block furnace starting method, an aluminum block furnace starting method, graphite furnace starting method and an electron beam gun furnace starting method is adopted.

3. The process of claim 2, wherein the iron block furnace starting method comprises following steps:
(a11) placing a silicon block or the silicon powder in an intermediate induction furnace, and simultaneously adding an iron block to the intermediate induction furnace;
(a12) starting the intermediate induction furnace, and raising a temperature to 1480-1520° C.; and
(a13) melting the silicon block or the silicon powder into a silicon liquid, and removing the iron block.

4. The process of claim 2, wherein the aluminum block furnace starting method comprises following steps:
(a21) placing a silicon block or the silicon powder in an intermediate induction furnace, and simultaneously adding an aluminum ingot to the intermediate induction furnace;
(a22) starting the intermediate induction furnace, and raising a temperature to 700-800° C. to melt the aluminum ingot to aluminum liquid;
(a23) continuously raising the temperature to 1700-1800° C. to melt the silicon block or the silicon powder into a silicon liquid;
(a24) gradually adding a silicon block or a silicon powder to the mixed liquid prepared in step (a23), so as to increase a silicon content in the silicon-aluminum mixed liquid; and as the mixed liquid in the intermediate induction furnace being full, removing 85%-95% of the mixed liquid and adding anew a silicon block or silicon powder gradually; and
(a25) repeating step (a24) until the silicon content in the mixed liquid reaching a standard, then completing the furnace starting.

5. The process of claim 2, wherein the graphite furnace starting method comprises following steps:
(a31) placing a silicon block or the silicon powder in an intermediate induction furnace, and simultaneously adding a graphite block to the intermediate induction furnace;
(a32) starting the intermediate induction furnace, and raising a temperature to 1800-1900° C.; and
(a33) melting the silicon block and the silicon powder to a silicon liquid, and removing the graphite block.

6. The process of claim 2, wherein the electron beam gun furnace starting method comprises following steps:
(a41) placing the silicon powder or a silicon block in an inside of an intermediate induction furnace;
(a42) starting an electron beam gun, and using the electron beam gun to heat the silicon powder or the silicon bock, so as to prepare a silicon liquid;
(a43) at the same time as performing step (b), starting the intermediate induction furnace to raise a temperature; and
(a44) after the silicon powder or the silicon block completely melting into the silicon liquid, stopping heating of the electron beam gun, and completing the furnace starting.

7. The process of claim 6, wherein in step (b), the silicon liquid is also stirred, wherein an operating procedure is: using a wood stick to stir the silicon liquid clockwise or counterclockwise in a single direction, and stir 2-3 cycles per minute.

8. The process of claim 6, wherein the operating frequency of the intermediate frequency furnace is 100-140 HZ.

9. The process of claim 2, wherein in step (b), the silicon liquid is also stirred, wherein an operating procedure is: using a wood stick to stir the silicon liquid clockwise or counterclockwise in a single direction, and stir 2-3 cycles per minute.

10. The process of claim 3, wherein in step (b), the silicon liquid is also stirred, wherein an operating procedure is: using a wood stick to stir the silicon liquid clockwise or counterclockwise in a single direction, and stir 2-3 cycles per minute.

11. The process of claim 4, wherein in step (b), the silicon liquid is also stirred, wherein an operating procedure is: using a wood stick to stir the silicon liquid clockwise or counterclockwise in a single direction, and stir 2-3 cycles per minute.

12. The process of claim 5, wherein in step (b), the silicon liquid is also stirred, wherein an operating procedure is: using a wood stick to stir the silicon liquid clockwise or counterclockwise in a single direction, and stir 2-3 cycles per minute.

13. The process of claim 6, wherein in step (b), the silicon liquid is also stirred, wherein an operating procedure is: using a wood stick to stir the silicon liquid clockwise or counterclockwise in a single direction, and stir 2-3 cycles per minute.

14. The process of claim 2, wherein the operating frequency of the intermediate frequency furnace is 100-140 HZ.

15. The process of claim 3, wherein the operating frequency of the intermediate frequency furnace is 100-140 HZ.

16. The process of claim 4, wherein the operating frequency of the intermediate frequency furnace is 100-140 HZ.

17. The process of claim 5, wherein the operating frequency of the intermediate frequency furnace is 100-140 HZ.

18. The process of claim 6, wherein the operating frequency of the intermediate frequency furnace is 100-140 HZ.
